(19) United States
(12) Patent Application Publication
(10) Pub. No.: US 2011/0165030 A1
(43) Pub. Date: Jul. 7, 2011

(54) INTERNAL RESISTIVE HEATING OF CATALYST BED FOR MONOPROPELLANT CATALYST

(75) Inventor: Jonathan Polaha, Seattle, WA (US)

(73) Assignee: Aerojet-General Corporation, a corporation of the state of Ohio, Sacramento, CA (US)

(21) Appl. No.: 12/948,558

(22) Filed: Nov. 17, 2010

Related U.S. Application Data
(60) Provisional application No. 61/292,397, filed on Jan. 5, 2010.

(51) Int. Cl. B01J 19/08

(52) U.S. Cl. 422/186.04

(57) ABSTRACT

Catalyst beds for monopropellant propulsion systems are heated by resistance heating through a conductive material that is incorporated in the catalyst bed and a pair of electrodes on opposite sides of the bed. Imposition of a voltage across the electrodes to heat the bed is performed at will without consumption of any heating components, and heating of the bed is achieved rapidly and uniformly across the entire bed.

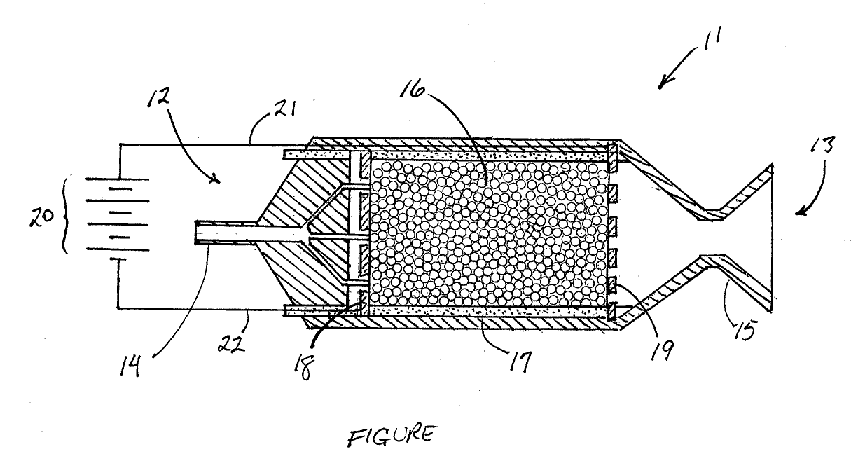

### CROSS-REFERENCE TO RELATED APPLICATION

This application claims the benefit of U.S. Provisional Patent Application No. 61/292,397, filed Jan. 5, 2010, the contents of which are incorporated herein by reference.

### BACKGROUND OF THE INVENTION

Monopropellants, so-called because they can be stored in a single container and will remain stable until exposed to catalysts that cause them to decompose to produce hot gases at large volumes, are a well known means of propulsion for rocket motors and other energetic systems. Monopropellants are typically liquid, with active components such as hydrogen peroxide, hydrazine, propylene glycol dinitrate, hydrogen ammonium perchlorate, hydroxylammonium nitrate (HAN), and other materials of a similar nature. One of the most common active components for monopropellants is HAN, which is typically combined with water and a fuel. Examples of materials used as the fuel are triethanol ammonium nitrate, 2-hydroxyethyl hydrazine nitrate, hydroxylamine (free base), diethylhydroxylamine (free base), dimethylhydroxylammonium nitrate, diethylhydroxylammonium nitrate, and others. The catalyst that induces the decomposition of the active component into hot gases is typically a solid catalyst which is either supported on an inert catalyst support, or unsupported such as a wire mesh or spongiform body of the catalytic material itself. Materials that serve as the catalyst, particularly for HAN, are generally platinum group metals, transition series metals, or combinations of platinum group and transition series metals. Examples are iridium, platinum, rhodium, rhenium, and vanadium. For supported catalysts, the inert, porous supports are typically alumina, silica, or other known refractory materials.

Monopropellant catalysts do not perform well at low temperatures and typically require auxiliary heat before they will initiate the decomposition of the propellant. Heating in the prior art has been accomplished by electrical heaters, glow plug devices, and electric sparks. These auxiliary heaters can be either embedded in the catalyst or external to the catalyst bed, but they tend to produce concentrated heat that does not quickly spread through the catalyst bed or, in the case of external heaters, heat that does not fully penetrate the external casings of the bed and other components to reach the bed. As an alternative to these auxiliary heaters, catalysts have been developed that are coated with an oxidizer that hypergolically reacts with the monopropellant. The heat from these catalysts, however, is generated only while the monopropellant is flowing through the catalyst bed, and ceases to be generated once the oxidizer coating is depleted. As a result, an engine that has been used and shut down cannot be re-started when needed.

### SUMMARY OF THE INVENTION

The present invention resides in a monopropellant catalyst bed that contains an electrically conductive path through the catalyst bed, allowing an electric current to be passed through the bed to produce rapid and uniform heat on demand throughout the bed, independently of the flow of monopropellant. The conductive path is formed by a conductive medium interspersed with, distributed throughout, or otherwise incorporated in the catalyst bed, a pair of electrodes at opposite ends or sides of the catalyst bed, and a power source to impose a voltage across the electrodes.

### BRIEF DESCRIPTION OF THE DRAWING

The Figure hereto is an axial cross section of a reaction chamber in accordance with the present invention.

### DETAILED DESCRIPTION

One example of a catalyst bed with an incorporated conductive medium is a large-pore foam (approximately 10 pores/inch) of conductive material such as silicon carbide, with catalyst granules residing in the pores. Another example is a series of concentric cylinders of a small-pore (approximately 80 pores per inch) foam, again fabricated of silicon carbide as an example, with catalyst granules residing between pairs of adjacent cylinders. A third example is a small-pore pore (approximately 80 pores per inch) foam, either continuous or in particulate form, with the catalyst metal deposited directly on the surface of the foam. Other known electrically conductive ceramics can serve as alternatives to silicon carbide. Examples are rhenium oxides, chromium oxide, vanadium oxide, and titanium oxide. These examples will prompt persons who are familiar with these and similar materials to know that still further examples that utilize the same basic concepts can be used. As noted above, the catalyst is preferably a metal selected from platinum group metals or transition series metals or combinations of metals from these groups, and particularly preferred metals are iridium, platinum, rhodium, rhenium, and vanadium. A convenient form of the metals is as a deposit on a metal oxide support, such as aluminum oxide and zirconium oxide. Catalysts of this type are products of Rocket Research Corporation (Seattle, Wash., USA) under product names beginning with the letters LCH. Examples are LCH-207 (12% iridium on alumina), LCH-210 (10% platinum on alumina), LCH-215 (12% rhodium on alumina), LCH-234(5% iridium on zirconia), LCH-237 (5% iridium on zirconia and cesium oxide), and LCH-240 (5% iridium on hafnium oxide). Granules ranging in size from 0.025 inch (0.064 cm) to 0.050 inch (0.13 cm) in diameter will be particularly effective when placed in the interstices of an open-cell foam of the electrically conductive material. The relative amounts of catalyst granules and electrically conductive material can vary. A typical range of the volumetric ratio of the catalyst granules to the electrically conductive material is from about 50:50 to about 90:10, and a specific example is about 70:30.

The electrodes can be formed of any material that can withstand the high temperatures and pressures generated by the decomposition of the monopropellant. Ceramic materials and metals are preferred. When placed along the axis of the gas flow, the electrodes can be perforated or otherwise fenestrated to allow the passage of gas (or liquid at the entry end) with at most a minimal pressure drop. Perforated laminates of silicon carbide or composites of carbon and silicon carbide are examples. Further examples are perforated sheets of rhenium or molybdenum-rhenium alloys. Alternatively, the electrodes can be formed by depositing a refractory metal on the end surfaces of the conductive foam that is incorporated into the catalyst bed.

In preferred embodiments of the invention, the reaction chamber in which the catalyst bed resides is electrically isolated from the adjacent components of the rocket motor or other equipment components with which the chamber is associated. Electrical isolation can be achieved by conventional insulating materials. Examples are non-conducting metal oxides and other ceramics, either in the form of plates or foams. The insulation will most often be placed radially relative to the direction of flow through the chamber, and in some cases the fore (upstream) and aft (downstream) ends of the chamber will be insulated as well. If placed at the fore and aft ends, the insulators will be perforated or fenestrated to allow passage of the fluid without a large pressure drop. At the aft end in particular, the insulation can also serve as a support to receive the impact of the flow of hot gases and to retain the catalyst and electrically conductive medium. This function can be achieved with a fiber-reinforced oxide or with a conical foam on whose surface alumina plasma has been sprayed.

The dimensions of the reaction chamber are not critical to the invention and can vary. For rocket motors, the dimensions can be the same as those of conventional monopropellant rocket motors. For example, the catalyst bed can occupy an internal volume ranging in diameter from about 0.5 inch (1.3 cm) to about 3 inches (7.6 cm), and from about 1 inch (2.5 cm) to about 3 inches (7.6 cm) in length.

The drawing attached hereto represents one example of an implementation of the invention. In this drawing, the thrust chamber 11 is cylindrical in shape and is shown with its fore end 12 on the left and its aft end 13 on the right. Liquid monopropellant enters the chamber through an inlet port 14 at the fore end and hot gases pass through a convergent-divergent nozzle 15 at the aft end. The combination of catalyst and conductive medium 16 are retained in the chamber interior, bounded by a cylindrical sleeve 17 of electrically insulating material. The catalyst/conductive medium bed is bounded at the fore end with a perforated electrode 18 and at the aft end with a second perforated electrode 19, each electrode joined to a power source 20 by lead wires 21, 22.

In the claims appended hereto, the term “a” or “an” is intended to mean “one or more.” The term “comprise” and variations thereof such as “comprises” and “comprising,” when preceding the recitation of a step or an element, are intended to mean that the addition of further steps or elements is optional and not excluded. All patents, patent applications, and other published reference materials cited in this specification are hereby incorporated herein by reference in their entirety. Any discrepancy between any reference material cited herein or any prior art in general and an explicit teaching of this specification is intended to be resolved in favor of the teaching in this specification. This includes any discrepancy between an art-understood definition of a word or phrase and a definition explicitly provided in this specification of the same word or phrase.

What is claimed is:

1. A catalyst-containing reaction chamber for a catalyst-activated monopropellant, said reaction chamber comprising:
a flow-through enclosure with a composite porous solid body retained therein, said solid body comprising a matrix of an electrically conductive material and a catalyst substantially uniformly distributed through said matrix, said catalyst active in decomposing a monopropellant,
a pair of electrodes in opposing relation with said solid body therebetween and in electrical contact with said matrix, and
a power source connected to impose a voltage across said electrodes and to thereby heat said catalyst by resistance heating of said electrically conductive material.

2. The reaction chamber of claim 1 wherein said electrically conductive material is a member selected from the group consisting silicon carbide, rhenium oxide, chromium oxide, vanadium oxide, and titanium oxide.

3. The reaction chamber of claim 1 wherein said electrically conductive material is silicon carbide.

4. The reaction chamber of claim 1 wherein said catalyst is a transition series metal.

5. The reaction chamber of claim 1 wherein said catalyst is a member selected from the group consisting of iridium, platinum, rhodium, rhenium, and vanadium.

6. The reaction chamber of claim 1 wherein said electrically conductive material is a porous foam of silicon carbide and said catalyst comprises catalyst granules residing in pores of said porous foam.

7. The reaction chamber of claim 1 wherein said electrically conductive material is a series of concentric cylinders of silicon carbide and said catalyst comprises catalyst granules residing between adjacent pairs of said cylinders.

8. The reaction chamber of claim 1 wherein said electrically conductive material comprises particles of silicon carbide and said catalyst comprises catalyst metal deposited on surfaces of said particles.

9. The reaction chamber of claim 1 wherein said electrodes are members selected from the group consisting of silicon carbide and composites of carbon and silicon carbide.

10. The reaction chamber of claim 1 further comprising a cylindrical sleeve of electrically insulating material between said composite porous solid body and said enclosure.
